(19) United States
(12) Patent Application Publication
(10) Pub. No.: US 2021/0110218 A1
(43) Pub. Date: Apr. 15, 2021

(54) ENVIRONMENT SENSING METHOD AND DEVICE, CONTROL METHOD AND DEVICE, AND VEHICLE

(71) Applicant: SZ DJI TECHNOLOGY CO., LTD., Shenzhen (CN)

(72) Inventor: Mingyu WANG, Shenzhen (CN)

(21) Appl. No.: 17/129,459

(22) Filed: Dec. 21, 2020

Related U.S. Application Data
(63) Continuation of application No. PCT/CN2019/074189, filed on Jan. 31, 2019.

(51) Int. Cl. G06K 9/62; G06N 3/08; G06N 3/04; G01S 15/04

(52) U.S. Cl. CPC G06K 9/6288; G06N 3/08; G01S 15/04; G06K 9/6232; G06N 3/0454

(57) ABSTRACT

An environment sensing method includes obtaining sound data captured by a sound sensor and image data captured by a vision sensor, and determining an environment recognition result according to the sound data and the image data.

### CROSS-REFERENCE TO RELATED APPLICATION

This application is a continuation of International Application No. PCT/CN2019/074189, filed on Jan. 31, 2019, the entire content of which is incorporated herein by reference.

### TECHNICAL FIELD

The present disclosure relates to the technical field of autonomous driving and, more particularly, to an environment sensing method and device, a control method and device, and a vehicle.

### BACKGROUND

Currently, sensors are used to sense surrounding environment in many scenarios. For example, autonomous vehicles use the sensors to sense the surrounding environment, so as to realize an automatic driving without any active human operation.

In the conventional technologies, compared with manually driven vehicles, the autonomous vehicles use multiple sensors and rely on artificial intelligence, visual computing, monitoring devices, and the like, to automatically operate the motor vehicles safely and reliably. The sensors of autonomous vehicles generally include vision sensors. The autonomous vehicles are controlled according to visual recognition of images captured by the vision sensors. However, there are limitations on images captured by the vision sensors. For example, the images captured at night generally have a low clarity, the images at a certain angle cannot be captured, or the like.

Therefore, because of the limitation on the images captured by the vision sensors, an environment sensing ability of the conventional technologies is limited.

### SUMMARY

In accordance with the disclosure, there is provided an environment sensing method including obtaining sound data captured by a sound sensor and image data captured by a vision sensor, and determining an environment recognition result according to the sound data and the image data.

Also in accordance with the disclosure, there is provided an environment sensing device including a memory storing program codes and a processor configured to execute the program codes to obtain sound data captured by a sound sensor and image data captured by a vision sensor, and determine an environment recognition result according to the sound data and the image data.

Also in accordance with the disclosure, there is provided a control method including obtaining sound data captured by a sound sensor and image data captured by a vision sensor, determining an environment recognition result according to the sound data and the image data, and controlling a vehicle according to the environment recognition result.

Also in accordance with the disclosure, there is provided a control device including a memory storing program codes and a processor configured to execute the program codes to obtain sound data captured by a sound sensor and image data captured by a vision sensor, determine an environment recognition result according to the sound data and the image data, and control a vehicle according to the environment recognition result.

Also in accordance with the disclosure, there is provided a non-transitory computer-readable storage medium storing a computer program including one or more codes that, when executed by a computer, cause the computer to obtain sound data captured by a sound sensor and image data captured by a vision sensor, and determine an environment recognition result according to the sound data and the image data.

Also in accordance with the disclosure, there is provided a vehicle including a sound sensor configured to capture sound data, a visual sensor configured to capture image data, and a control device including a memory storing program codes and a processor. The processor is configured to execute the program codes to obtain the sound data and the image data, determine an environment recognition result according to the sound data and the image data, and control the vehicle according to the environment recognition result.

### BRIEF DESCRIPTION OF THE DRAWINGS

In order to provide a clearer illustration of technical solutions of disclosed embodiments, the drawings used in the description of the disclosed embodiments are briefly described below. It will be appreciated that the disclosed drawings are merely examples and other drawings conceived by those having ordinary skills in the art on the basis of the described drawings without inventive efforts should fall within the scope of the present disclosure.

FIG. 1 is a schematic flow chart of an environment sensing method consistent with embodiments of the disclosure.

FIG. 2 is a schematic flow chart of another environment sensing method consistent with embodiments of the disclosure.

FIG. 3A schematically shows fusing information carried by sound data and image data consistent with embodiments of the disclosure.

FIG. 3B schematically shows determining an environment recognition result based on a neural network consistent with embodiments of the disclosure.

FIG. 4 schematically shows training a first neural network consistent with embodiments of the disclosure.

FIG. 5 schematically shows positions of sound sensors and vision sensors consistent with embodiments of the disclosure.

FIG. 6 is a schematic flow chart of a control method based on environment sensing consistent with embodiments of the disclosure.

FIG. 7 is a schematic structural diagram of an environment sensing device consistent with embodiments of the disclosure.

FIG. 8 is a schematic structural diagram of a control device based on environment sensing consistent with embodiments of the disclosure.

FIG. 9 is a schematic structural diagram of a vehicle consistent with embodiments of the disclosure.

### DETAILED DESCRIPTION OF THE EMBODIMENTS

In order to provide a clearer illustration of technical solutions of disclosed embodiments, example embodiments will be described with reference to the accompanying drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The present disclosure provides an environment sensing method for sensing surrounding environment using a sound sensor and a vision sensor. The sound sensor can be introduced on the basis of the vision sensor to avoid a limitation of an environment sensing ability caused by limitations of images captured by the vision sensor (e.g., a clarity of the captured images greatly affected by a brightness of the environment, content of the captures image greatly affected by an installation angle, and the like).

The environment sensing method consistent with the disclosure can be applied to any device that needs to perform environment sensing. In some embodiments, the environment sensing method can be applied to a device having a fixed location to sense the surrounding environment, or can be applied to a mobile device to sense the surrounding environment. In some embodiments, the environment sensing method consistent with the disclosure can be applied to vehicles to sense the surrounding environment in the field of autonomous vehicles. Autonomous vehicles can also be referred to as unmanned vehicles, computer-driven vehicles, or wheeled mobile robots, and the like.

The type of the vision sensor can include, for example, a monocular vision sensor, a binocular vision sensor, and the like, which is not limited herein.

Hereinafter, example embodiments will be described with reference to the accompanying drawings. Unless conflicting, the exemplary embodiments and features in the exemplary embodiments can be combined with each other.

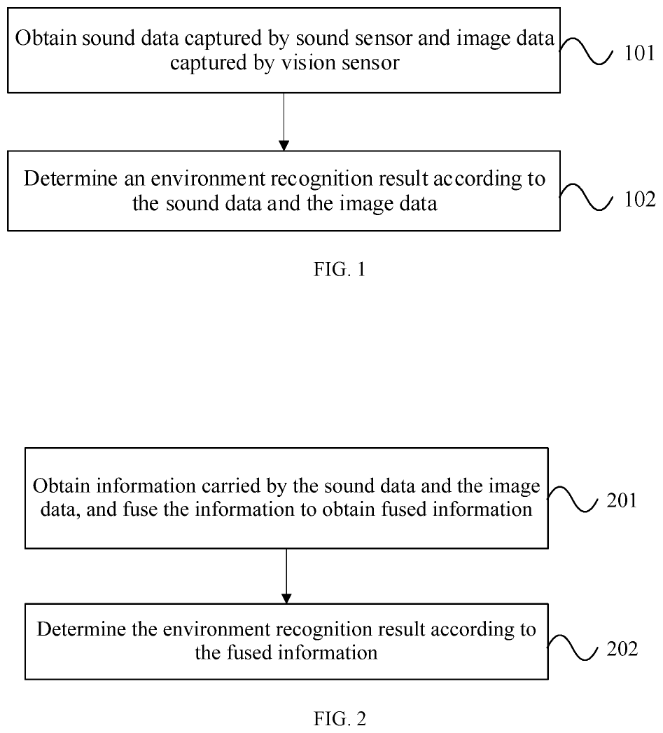

FIG. 1 is a schematic flow chart of an example environment sensing method consistent with the disclosure. An execution entity of the environment sensing method may include a device that needs to perform the environment sensing, or a processor of the device.

As shown in FIG. 1, at 101, sound data captured by the sound sensor and image data captured by the vision sensor are obtained. In some embodiments, the sound sensor and the vision sensor may be arranged at the device that needs to perform the environment sensing, and used for sensing the surrounding environment based on the data captured by the sound sensor and the vision sensor. For the device having the fixed location, the sound sensor and/or the vision sensor can be arranged at another device close to the device and having a relatively fixed location.

In some embodiments, the device can have one or more sound sensors and one or more vision sensors. In some embodiments, obtaining the sound data captured by the sound sensor at 101 may include obtaining the sound data captured by at least one of a plurality of sound sensors arranged at the device. In some embodiments, obtaining the image data captured by the vision sensor at 101 may include obtaining the image data captured by at least one of a plurality of vision sensors arranged at the device.

The sound data captured by the sound sensor can include, for example, analog data or digital data, which is not limited herein. The image data captured by the vision sensor may include, for example, pixel values of multiple pixels.

At 102, an environment recognition result is determined according to the sound data and the image data. The environment recognition result can be determined according to not only the image data captured by the vision sensor, but also the sound data captured by the sound sensor. Compared with determining the environment recognition result according to only the image data captured by the vision sensor but not the sound data captured by the sound sensor, the method consistent with the disclosure provides more dimensions of the data based on which the environment recognition result is determined. The sound data captured by the sound sensor does not have the limitations similar to the images captured by the vision sensor. For example, the sound data captured by the sound sensor can be less affected by the brightness of the environment and the installation angle of the sensor. Therefore, the environment recognition result determined according to the sound data and the image data can avoid the limitation of the environment sensing ability caused by the limitations of images captured by the vision sensor, and improve the environment sensing ability.

A manner of determining the environment recognition result according to the sound data and the image data is not limited herein. In some embodiments, a first environment recognition result may be determined according to the sound data, a second environment recognition result may be determined according to the image data, and a final environment recognition result may be determined according to the first environment recognition result and the second environment recognition result. For example, one of the first environment recognition result and the second environment recognition result can be selected as the final environment recognition result.

The environment recognition result can include, for example, what a target is (e.g., a pedestrian, a vehicle, or the like), which is not limited herein.

Consistent with the disclosure, the sound data captured by the sound sensor and the image data captured by the vision sensor can be obtained. The environment recognition result can be determined according to the sound data and the image data. The method can determine the environment recognition result using not only the image data captured by the vision sensor, but also the sound data captured by the sound sensor. Since the sound data captured by the sound sensor does not have the limitations similar to the image captured by the vision sensor, the environment recognition result determined based on the sound data and image data can avoid the limitation of the environment sensing ability caused by the limitations of images captured by the vision sensor, and improve the environment sensing ability.

FIG. 2 is a schematic flow chart of another example environment sensing method consistent with the disclosure. On the basis of the method in FIG. 1, FIG. 2 shows an example implementation of the process at 102.

As shown in FIG. 2, at 201, information carried by the sound data and the image data is obtained, and the information is fused to obtain fused information. The sound information carried by the sound data and the image information carried by the image data can be obtained, and the obtained sound information and image information can be fused. The sound information can include effective information carried in the sound data captured by the sound sensor. In some embodiments, the effective information can include time domain information, frequency domain information, or the like. The time domain information can be used to determine a speed of the target and a distance to the target, and the frequency domain information can be used to determine a type of the target (e.g., a person, a car, an engineering vehicle, or the like). The image information can include feature information carried in the image data captured by the vision sensor, for example, a gray value of each pixel.

At 202, the environment recognition result is determined according to the fused information.

A manner of fusing the information can include, for example, using a neural network to fuse the information carried by the sound data and the image data, which is not limited herein.

In some embodiments, the process at 201 may include inputting the sound data to a first neural network to obtain an output result of the first neural network, and inputting the output result of the first neural network and the image data to a second neural network to obtain an output result of the second neural network. The output result of the second neural network can include the environment recognition results of a first channel and a second channel of the second neural network. The first channel can include a channel associated with the sound data, and the second channel can include a channel associated with the image data.

The environment recognition results of the first channel and the second channel of the second neural network can be considered to be the fused information.

The types of the first neural network and the second neural network are not limited herein. In some embodiments, the first neural network may include a convolutional neural network (CNN), e.g., CNN1. The second neural network may include a CNN, e.g., CNN2.

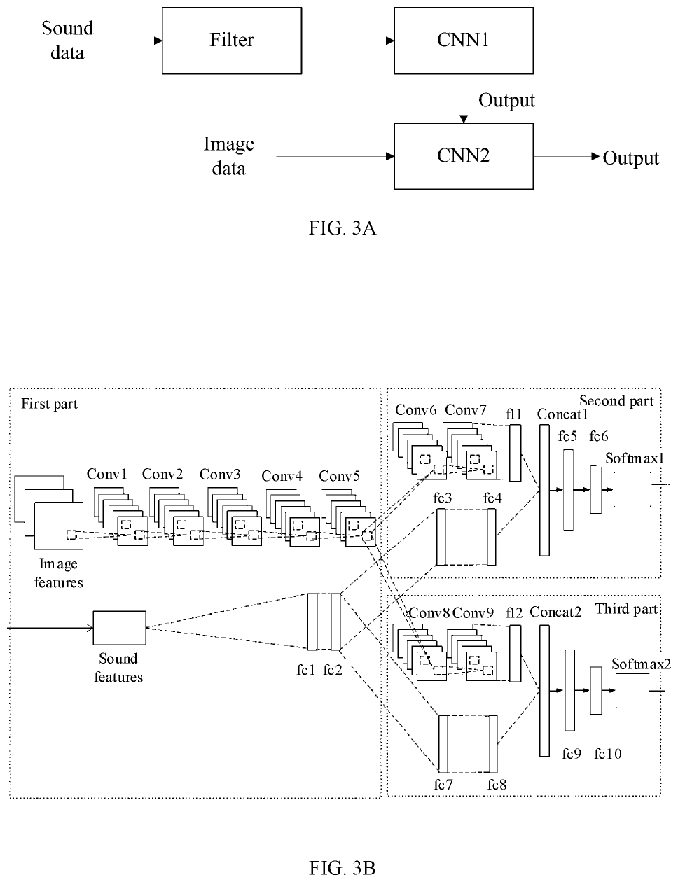

FIG. 3A schematically shows fusing the information carried by sound data and image data consistent with the disclosure. FIG. 3A takes CNN1 and CNN2 as examples of the first neural network and the second neural network. As shown in FIG. 3A, the method consistent with the disclosure may further include performing filter processing on the sound data captured by the sound sensor to obtain filtered sound data, and inputting the filtered sound data to the first neural network.

When there is no need to reduce an implementation complexity, the sound data and the image data can be input to one neural network to obtain the output result of the neural network. The output result of the neural network can include the environment recognition results of the first channel and the second channel of the neural network. The first channel can be referred to as the channel associated with the sound data, and the second channel can be referred to as the channel associated with the image data.

In some embodiments, the process at 202 can include determining the final environment recognition result according to the environment recognition result of the first channel, a confidence level of the first channel, the environment recognition result of the second channel, and a confidence level of the second channel. In some embodiments, when the confidence of the first channel is higher than the confidence of the second channel, the environment recognition result of the first channel may be used as the final environment recognition result. When the confidence of the first channel is lower than the confidence of the second channel, the environment recognition result of the second channel can be used as the final environment recognition result. When the confidence of the first channel is close to the confidence of the second channel, either the environment recognition result of the first channel or the environment recognition result of the second channel may be selected as the final environment recognition result.

In some embodiments, the output result of the first neural network may include the distance to the target, and the distance may be used to correct an error of depth information obtained by the vision sensor.

In some embodiments, weights can be set to control importance degrees of the environment recognition results of the first channel and the second channel when the final environment recognition result is being determined. Determining the final environment recognition result according to the environment recognition result of the first channel, the confidence level of the first channel, the environment recognition result of the second channel, and the confidence level of the second channel can include determining the final environment recognition result according to the environment recognition result of the first channel, the confidence level of the first channel, the weight of the first channel, the environment recognition result of the second channel, the confidence level of the second channel, and the weight of the second channel.

In some embodiments, when a calculation result of a first operation of the confidence level of the first channel and the weight of the first channel is higher than a calculation result of the first operation of the confidence level of the second channel and the weight of the second channel, the environment recognition result of the first channel can be used as the final environment recognition result. When the calculation result of the first operation of the confidence level of the first channel and the weight of the first channel is lower than the calculation result of the first operation of the confidence level of the second channel and the weight of the second channel, the environment recognition result of the second channel can be used as the final environment recognition result. When the calculation result of the first operation of the confidence level of the first channel and the weight of the first channel is equal to the calculation result of the first operation of the confidence level of the second channel and the weight of the second channel, either the environment recognition result of the first channel or the environment recognition result of the second channel may be selected as the final environment recognition result.

The first operation may include an operation in which a result of the operation is positively correlated with both the confidence level and the weight. For example, the first operation may include a summation operation, a product operation, and/or the like.

In some embodiments, the weight of the first channel can include a fixed weight, or the weight of the first channel can be positively related to a degree of influence on the vision sensor by the environment. For example, a greater degree of influence on the vision sensor by the environment corresponds to a greater weight of the first channel associated with the sound data.

In some embodiments, the weight of the second channel can include a fixed weight, or, the weight of the second channel can be negatively related to the degree of influence on the vision sensor by the environment. For example, a greater degree of influence on the vision sensor by the environment corresponds to a less weight of the second channel associated with the image data.

A combination relationship of the weight of the first channel and the weight of the second channel is not limited herein. For example, the weight of the first channel may include the fixed weight, and the weight of the second channel may be negatively related to the degree of influence on the vision sensor by the environment.

The greater degree of influence on the vision sensor by the environment can represent the lower clarity of the image captured by the vision sensor due to the influence of the environment (e.g., the influence of the brightness of the environment). The smaller degree of influence on the vision sensor by the environment can represent the higher clarity of the image captured by the vision sensor due to the influence of the environment.

For example, the weight of the vision sensor can be greater than the weight of the sound sensor in the daytime (an application scenario). The weight of the vision sensor can be less than the weight of the sound sensor at night (another application scenario).

In some embodiments, the output result of the second neural network can further include feature information determined from the image data, and the feature information can be used to characterize a current environment state. The method in FIG. 2 can further include determining the weight of the first channel and/or the weight of the second channel according to the feature information. In some embodiments, the current environment state may include a current environment brightness and/or a current weather. For example, the weight of the first channel can include Weight 1. In the daytime, the weight of the second channel can include Weight 2. At night, the weight of the second channel can include Weight 3. Weight 1 can be less than Weight 2, and Weight 1 can be greater than Weight 3. As another example, the weight of the second channel may include Weight 4. In the daytime, the weight of the first channel can include Weight 5. At night, the weight of the first channel can include Weight 6. Weight 5 can be less than Weight 4, and Weight 6 can be greater than Weight 4. As another example, in daytime and sunny days, the weight of the first channel can include Weight 7, and the weight of the second channel can include Weight 8. In daytime and rainy days, the weight of the first channel can include Weight 9, and the weight of the second channel can include Weight 10. Weight 7 can be less than Weight 8, and Weight 9 can be greater than Weight 10.

FIG. 3B schematically shows determining the environment recognition result based on the neural network consistent with the disclosure. For an application scenario, as shown in FIG. 3B, in a first part of the neural network, image features corresponding to the image data can be output to a second part of the neural network after being processed by convolutional layers conv1 to conv5. In the second part, the image featured can be further processed by convolutional layers conv6 and conv7 and a convolutional layer f11 implementing a flat function (an output of the convolutional layer f11 can be regarded as the environment recognition result of the second channel). Sound features corresponding to the sound data can be processed by output layers fc1 and fc2 and then output to the second part, and in the second part, the sound features can be processed by output layers fc3 and fc4 (an output of the output layer fc4 can be considered as the environment recognition result of the first channel). The final environment recognition result can be obtained by processing the output of fc4 and the output of f11 through a convolutional layer concat1 realizing a concat function, output layers fc5 and fc6, and a convolutional layer Softmax1 realizing a soft maximum function.

For another application scenario, as shown in FIG. 3B, in the first part, the image features corresponding to the image data can be processed by the conv1 to conv5 and then output to a third part of the neural network. In the third part, the image features can be processed by conv8 and conv9 and a convolutional layer f12 implementing the flat function (an output of the convolutional layer f12 can be considered as the environment recognition result of the second channel). The sound features corresponding to the sound data can be processed by the output layers fc1 and fc2 and then output to the third part. In the third part, the sound features can be processed by output layers fc7 and fc8 (an output of the output layer fc8 can be considered as the environment recognition result of the first channel). The final environment recognition can be obtained by processing the output of fc8 and the output of f12 through a convolutional layer concat2 realizing the concat function, output layers fc9 and fc10, and a convolutional layer Softmax2 realizing the soft maximum function.

FIG. 3B takes the neural network including the preloaded second part corresponding to one application scenario and the preloaded third part corresponding to another application scenario as an example. It can be appreciated that one of the second part or the third part corresponding to a current application scenario can be selected to reduce resource occupation.

When the sound data is manually labeled, such as one sound data can be marked as the sound of an electric car, another sound data can be marked as the sound of a car, and another sound data can be marked as the sound of an engineering vehicle, the processing can be relatively cumbersome and a difficulty of training can be higher. In some embodiments, labels of the sample voice data can be determined through an output of the second neural network. In some embodiments, the first neural network can include a neural network trained based on sample sound data and identification marks. The identification marks can include the output result of the second neural network after the sample image data corresponding to the sample sound data is input to the second neural network. Through using the output result of the second neural network, after inputting the sample image data corresponding to the sample sound data to the second neural network, as the identification marks, the difficulty of training can be greatly reduced.

In some embodiments, during the daytime when the weather is clear, the image sensor and the sound sensor can be used to capture the image data and sound data at the same time. The captured image data can be input to the second neural network CNN2, and the output of the second neural network may contain semantic information of various objects in the surrounding environment. For example, the surrounding objects can include electric cars, cars, pedestrians, lane lines, and the like. The semantics of the output of the second neural network can be used as result data of the first neural network to train the first neural network. Therefore, in the training process of the first neural network, the sound data captured by the sound sensor can be used as the input, and the recognition result of image data captured at the same time as the sound data can be used as the output. As such, a complexity of training the first neural network can be simplified, and there is no need to manually label the sound data.

In some embodiments, the sound data can be filtered before being input to CNN1 for training, so as to filter out background noise.

In some embodiments, before the sound data is input to CNN1 for training, Fourier transform can be performed on some pieces of the data, and the captured time domain signal and frequency domain signal can be input to CNN1 for training.

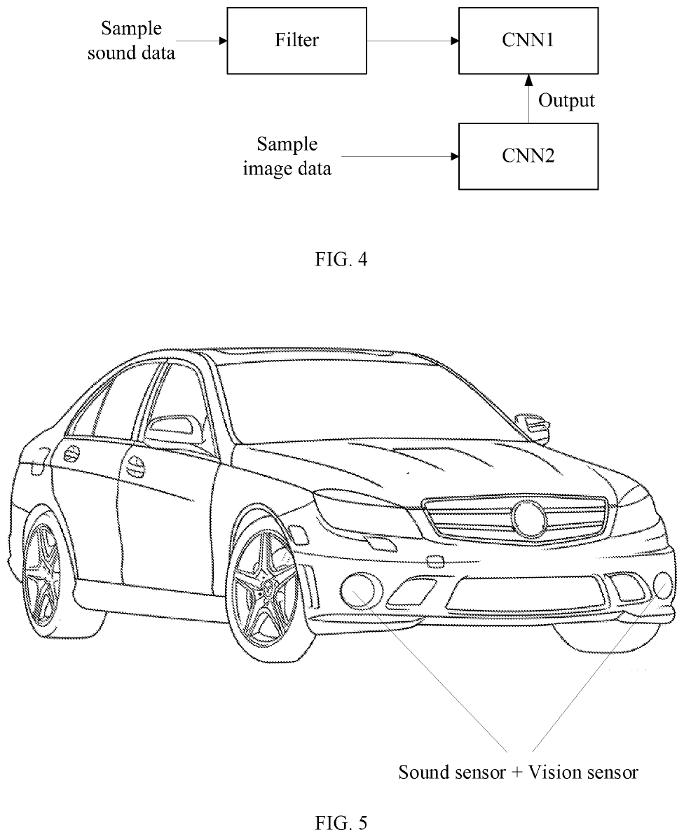

FIG. 4 schematically shows training the first neural network consistent with the disclosure. The training process shown in FIG. 4 takes CNN1 being the first neural network and CNN2 being the second neural network as an example.

In some embodiments, as shown in FIG. 4, the method consistent with the disclosure can further include performing the filter processing on the sample sound data to obtain filtered sample sound data, and inputting the filtered sample sound data to the first neural network.

Determining the environment recognition result according to the sound data captured by the sound sensor and the image data captured by the vision sensor is described above. In some embodiments, the environment recognition result can be also determined based on data captured by sensors other than sound sensor and vision sensor.

In some embodiments, the method consistent with the disclosure can further include obtaining radar data captured by a radar sensor. The process at 202 may include determining the environment recognition result according to the radar data, the sound data, and the image data.

A manner of determining the environment recognition result according to the radar data, the sound data, and the image data is not limited herein. In some embodiments, determining the environment recognition result according to the radar data, the sound data and the image data may include fusing the radar data and the image data to obtain fused data, obtaining the information carried by the sound data and the fused data, fusing the information to obtain the fused information, and determining the environment recognition result according to the fused information.

The radar data captured by the radar sensor can include point cloud data, and the image data can include data composed of many pixels. Therefore, the radar data and the image data can be fused to obtain the fused data.

The method of obtaining and fusing the information carried by the sound data and the fused data can be similar to the method of obtaining and fusing the information carried by the sound data and the image data, and detailed description thereof is omitted herein.

In some embodiments, the sound sensor and the vision sensor can be separately arranged (e.g., the sound sensor and the vision sensor can be set apart from each other), and two coordinates systems can be established for the sound sensor and the vision sensor, respectively. Based on the data captured by the sound sensor and the vision sensor, the target object can be determined in the two coordinate systems, and the positions of the target object in the two coordinate systems can be converted into a position in a same coordinate system through a coordinate system conversion. The working principles of the vision sensor and the sound sensor are different. An optical signal is transmitted in a form of electromagnetic waves according to the principle of optical propagation, and the sound is transmitted in the form of waves in a medium. Furthermore, the transmissions of the optical signal and the sound are also affected by the surrounding environment. If the sound sensor and the vision sensor are far apart, factors of the form of propagation and environment influence, such as the Doppler effect and multipath transmission effect, can be amplified, thereby causing source deviations in the process of capturing data and further causing a deviation of feature recognition of the target.

In some embodiments, the sound sensor and the vision sensor can be arranged at positions adjacent to each other. In some embodiments, the sound sensor and the vision sensor can be arranged at a same position by using an electronic unit integrating the vision sensor and the sound sensor. Arranging the sound sensor and the vision sensor at the same position can reduce a computational complexity in the process of determining the target object and reduce an error introduced by a computational algorithm. Arranging the sound sensor and the vision sensor at the same position can ensure a consistency of the information received by the two sensors to the greatest extent, so as to minimize the deviation of the feature recognition of the target caused by the deviation of the information source due to the separation of the sound sensor and the vision sensor. In some embodiments, arranging the sound sensor and the vision sensor at the same position can include arranging the sound sensor and the vision sensor nearly at the same position by arranging them adjacent to each other, or arranging a sound sensor array to surround the vision sensor.

A position of the sound sensor can be referred to as a “first position” and a position of the vision sensor can be referred to as a “second position.” In some embodiments, a distance between the first position and the second position can be set to 0, e.g., the sound sensor and the vision sensor can be integrated together. FIG. 5 schematically shows the positions of the sound sensors and vision sensors consistent with the disclosure. As shown in FIG. 5, the sound sensor and the vision sensor are integrated together and arranged in the front of a vehicle.

In some embodiments, when the distance between the first position and the second position is greater than 0, the coordinate systems can be converted between the sound sensor and the vision sensor, and when the distance between the first position and the second position is equal to 0, there is no need to convert the coordinate systems between the sensors.

Consistent with the disclosure, the information carried by the sound data and the image data can be obtained, and the information can be fused to obtain the fused information. According to the fused information, the environment recognition result can be determined. Therefore, not only the image data captured by the vision sensor but also the sound data captured by the sound sensor can be used to determine the environment recognition result, thereby improving the environment sensing ability.

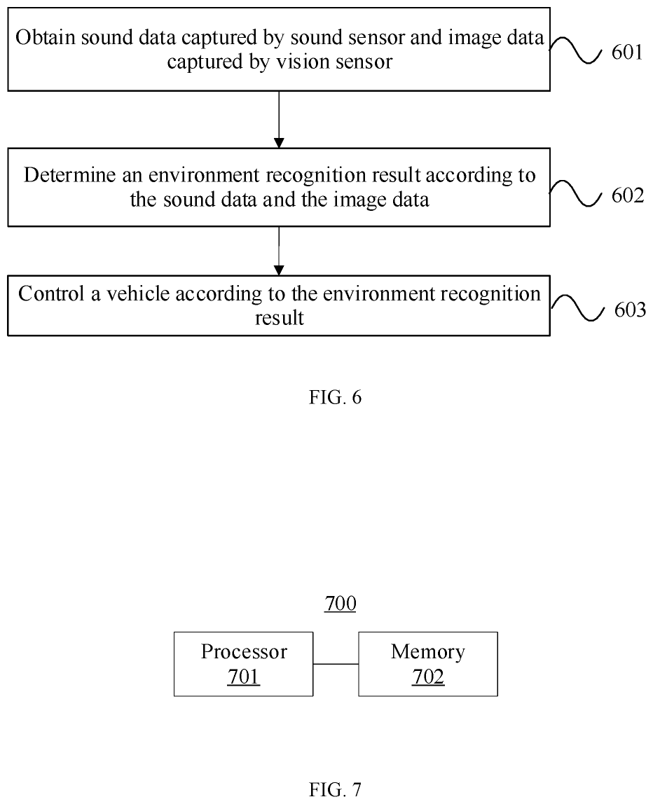

FIG. 6 is a schematic flow chart of an example control method based on environment sensing (environment-sensing-based control method) consistent with the disclosure. An execution entity of the control method can include a device (e.g., a vehicle) that needs to perform a control based on environment sensing or a processor of the device.

As shown in FIG. 6, at 601, the sound data captured by the sound sensor and the image data captured by the vision sensor are obtained.

At 602, the environment recognition result is determined according to the sound data and the image data.

In some embodiments, determining the environment recognition result according to the sound data and the image data can include obtaining the information carried by the sound data and the image data, fusing the information to obtain the fused information, and determining the environment recognition result according to the fused information.

In some embodiments, obtaining the information carried by the sound data and the image data and fusing the information to obtain the fused information can include inputting the sound data to the first neural network to obtain the output result of the first neural network, and inputting the output result of the first neural network and the image data to the second neural network to obtain the output result of the second neural network. The output result of the second neural network can include the environment recognition results of the first channel and the second channel of the second neural network. The first channel can be referred to as the channel associated with the sound data, and the second channel can be referred to as the channel associated with the image data.

In some embodiments, determining the environment recognition result according to the fused information can include determining the final environment recognition result according to the environment recognition result of the first channel, the confidence level of the first channel, the environment recognition result of the second channel, and the confidence level of the second channel.

In some embodiments, determining the final environment recognition result according to the environment recognition result of the first channel, the confidence level of the first channel, the environment recognition result of the second channel, and the confidence level of the second channel can include determining the final environment recognition result according to the environment recognition result of the first channel, the confidence level of the first channel, the weight of the first channel, the environment recognition result of the second channel, the confidence level of the second channel, and the weight of the second channel.

In some embodiments, the weight of the first channel can include a fixed weight. In some embodiments, the weight of the second channel can include a fixed weight. In some embodiments, the weight of the first channel can be positively related to the degree of influence on the vision sensor by the environment. In some embodiments, the weight of the second channel can be negatively related to the degree of influence on the vision sensor by the environment.

In some embodiments, the output result of the second neural network can further include the feature information determined from the image data, and the feature information can be used to characterize the current environment state.

The control method can further include determining the weight of the first channel and/or the weight of the second channel according to the feature information.

In some embodiments, the first neural network can include the neural network trained based on the sample sound data and the identification marks. The identification marks can include the output result of the second neural network after the sample image data corresponding to the sample sound data is input to the second neural network.

In some embodiments, the control method can further include obtaining the radar data captured by the radar sensor. Determining the environment recognition result according to the sound data and the image data can include determining the environment recognition result according to the radar data, the sound data, and the image data.

In some embodiments, determining the environment recognition result according to the radar data, the sound data, and the image data can include fusing the radar data and the image data to obtain the fused data, obtaining the information carried by the sound data and the fused data, fusing the information to obtain the fused information, and determining the environment recognition result according to the fused information.

In some embodiments, the sound sensor can be arranged at the first position and the vision sensor can be arranged at the second position. The distance between the first position and the second position can be greater than or equal to 0 and less than a distance threshold. In some embodiments, the distance between the first position and the second position is equal to 0, in which case the sound sensor and the vision sensor can be integrated together.

The processes at 601 and 602 are similar to the processes of the methods in FIG. 1 and FIG. 2, and detailed description thereof is omitted herein.

At 603, the vehicle is controlled according to the environment recognition result. In some embodiments, a speed, a driving direction, and/or the like, of the vehicle can be controlled according to the environment recognition result.

The environment recognition result determined by the processes at 601 and 602 can avoid the limitation of the environment sensing ability caused by the limitations of images captured by the vision sensor, thereby causing the environment recognition result more accurate. Therefore, when the vehicle is controlled according to the environment recognition result, a robustness of vehicle control can be improved.

Consistent with the disclosure, the sound data captured by the sound sensor and the image data captured by the vision sensor can be obtained. The environment recognition result can be determined according to the sound data and the image data. The vehicle can be controlled according to the environment recognition result. The environment recognition result can be more accurate, thereby improving the robustness of vehicle control.

The present disclosure further provides a computer readable storage medium, and the computer readable storage medium can store program instructions. The execution of the program may include the implementation of some or all of the processes of the environment sensing method consistent with the disclosure (e.g., the methods in FIGS. 1 and 2).

The present disclosure further provides another computer readable storage medium, and the computer readable storage medium can store program instructions. The execution of the program may include the implementation of some or all of the processes of the control method based on environment sensing consistent with the disclosure (e.g., the method in FIG. 6).

The present disclosure further provides a computer program, and when the computer program is executed by a computer, the environment sensing method consistent with the disclosure (e.g., the methods in FIGS. 1 and 2) can be implemented.

The present disclosure further provides a computer program, and when the computer program is executed by a computer, the control method based on environment sensing consistent with the disclosure (e.g., the method in FIG. 6) can be implemented.

FIG. 7 is a schematic structural diagram of an example environment sensing device 700 consistent with the disclosure. As shown in FIG. 7, the environment sensing device 700 includes a memory 701 and a processor 702. The memory 701 and the processor 702 may be connected through a bus. The memory 701 may include a read-only memory and a random access memory, and provide instructions and data to the processor 702. A portion of the memory 701 may also include a non-volatile random access memory. The memory 701 can store program codes.

The processor 702 can be configured to call the program codes. When the program codes are executed, the processor 702 can obtain the sound data captured by the sound sensor and the image data captured by the vision sensor, and determine the environment recognition result according to the sound data and the image data.

In some embodiments, when determining the environment recognition result according to the sound data and the image data, the processor 702 can obtain the information carried by the sound data and the image data, fuse the information to obtain the fused information, and determine the environment recognition result according to the fused information.

In some embodiments, when obtaining the information carried by the sound data and the image data and fusing the information to obtain the fused information, the processor 702 can input the sound data to the first neural network to obtain the output result of the first neural network, and input the output result of the first neural network and the image data to the second neural network to obtain the output result of the second neural network. The output result of the second neural network can include the environment recognition results of the first channel and the second channel of the second neural network. The first channel can be referred to as the channel associated with the sound data, and the second channel can be referred to as the channel associated with the image data.

In some embodiments, when determining the environment recognition result according to the fused information, the processor 702 can determine the final environment recognition result according to the environment recognition result of the first channel, the confidence level of the first channel, the environment recognition result of the second channel, and the confidence level of the second channel.

In some embodiments, when determining the final environment recognition result according to the environment recognition result of the first channel, the confidence level of the first channel, the environment recognition result of the second channel, and the confidence level of the second channel, the processor 702 can determine the final environment recognition result according to the environment recognition result of the first channel, the confidence level of the first channel, the weight of the first channel, the environment recognition result of the second channel, the confidence level of the second channel, and the weight of the second channel.

In some embodiments, the weight of the first channel can include a fixed weight. In some embodiments, the weight of the second channel can include a fixed weight. In some embodiments, the weight of the first channel can be positively related to the degree of influence on the vision sensor by the environment. In some embodiments, the weight of the second channel can be negatively related to the degree of influence on the vision sensor by the environment.

In some embodiments, the output result of the second neural network can further include the feature information determined from the image data, and the feature information can be used to characterize the current environment state.

The processor 702 can be further configured to determine the weight of the first channel and/or the weight of the second channel according to the feature information.

In some embodiments, the first neural network can include the neural network trained based on the sample sound data and the identification marks. The identification marks can include the output result of the second neural network after the sample image data corresponding to the sample sound data is input to the second neural network.

In some embodiments, the processor 702 can be further configured to obtain the radar data captured by the radar sensor. When determining the environment recognition result according to the sound data and the image data, the processor 702 can determine the environment recognition result according to the radar data, the sound data, and the image data.

In some embodiments, when determining the environment recognition result according to the radar data, the sound data, and the image data, the processor 702 can fuse the radar data and the image data to obtain the fused data, obtain the information carried by the sound data and the fused data, fuse the information to obtain the fused information, and determine the environment recognition result according to the fused information.

In some embodiments, the sound sensor can be arranged at the first position and the vision sensor can be arranged at the second position. The distance between the first position and the second position can be greater than or equal to 0 and less than the distance threshold. In some embodiments, when the distance between the first position and the second position is equal to 0, the sound sensor and the vision sensor can be integrated.

The environment sensing device consistent with the disclosure can be configured to implement the environment sensing method consistent with the disclosure (e.g., the methods in FIGS. 1 and 2). The implementation principles and technical effects of the environment sensing device 700 are similar to those of the environment sensing method described above, and detailed description thereof is omitted herein.

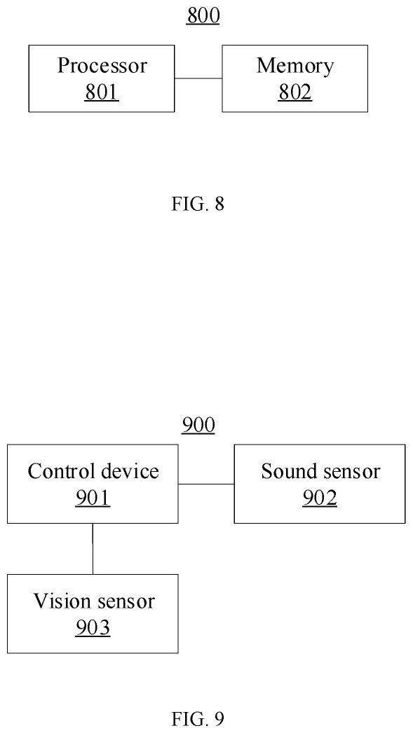

FIG. 8 is a schematic structural diagram of an example control device 800 based on environment sensing (environment-sensing-based control device) consistent with the disclosure. As shown in FIG. 8, the control device 800 based on environment sensing includes a memory 801 and a processor 802. The memory 801 and the processor 802 may be connected through a bus. The memory 801 may include a read-only memory and a random access memory, and provide instructions and data to the processor 802. A portion of the memory 801 may also include a non-volatile random access memory. The memory 801 can store program codes.

The processor 802 can be configured to call the program codes. When the program codes are executed, the processor 802 can obtain the sound data captured by the sound sensor and the image data captured by the vision sensor, determine the environment recognition result according to the sound data and the image data, and control the vehicle according to the environment recognition result.

In some embodiments, when determining the environment recognition result according to the sound data and the image data, the processor 802 can obtain the information carried by the sound data and the image data, fuse the information to obtain the fused information, and determine the environment recognition result according to the fused information.

In some embodiments, when obtaining the information carried by the sound data and the image data and fusing the information to obtain the fused information, the processor 802 can input the sound data to the first neural network to obtain the output result of the first neural network, and input the output result of the first neural network and the image data to the second neural network to obtain the output result of the second neural network. The output result of the second neural network can include the environment recognition results of the first channel and the second channel of the second neural network. The first channel can be referred to as the channel associated with the sound data, and the second channel can be referred to as the channel associated with the image data.

In some embodiments, when determining the environment recognition result according to the fused information, the processor 802 can determine the final environment recognition result according to the environment recognition result of the first channel, the confidence level of the first channel, the environment recognition result of the second channel, and the confidence level of the second channel.

In some embodiments, when determining the final environment recognition result according to the environment recognition result of the first channel, the confidence level of the first channel, the environment recognition result of the second channel, and the confidence level of the second channel, the processor 802 can determine the final environment recognition result according to the environment recognition result of the first channel, the confidence level of the first channel, the weight of the first channel, the environment recognition result of the second channel, the confidence level of the second channel, and the weight of the second channel.

In some embodiments, the weight of the first channel can include a fixed weight. In some embodiments, the weight of the second channel can include a fixed weight. In some embodiments, the weight of the first channel can be positively related to the degree of influence on the vision sensor by the environment. In some embodiments, the weight of the second channel can be negatively related to the degree of influence on the vision sensor by the environment.

In some embodiments, the output result of the second neural network can further include the feature information determined from the image data, and the feature information can be used to characterize the current environment state.

The processor 802 can be further configured to determine the weight of the first channel and/or the weight of the second channel according to the feature information.

In some embodiments, the first neural network can include the neural network trained based on the sample sound data and the identification marks. The identification marks can include the output result of the second neural network after the sample image data corresponding to the sample sound data is input to the second neural network.

In some embodiments, the processor 802 can be further configured to obtain the radar data captured by the radar sensor. When determining the environment recognition result according to the sound data and the image data, the processor 802 can determine the environment recognition result according to the radar data, the sound data, and the image data.

In some embodiments, when determining the environment recognition result according to the radar data, the sound data, and the image data, the processor 802 can fuse the radar data and the image data to obtain the fused data, obtain the information carried by the sound data and the fused data, fuse the information to obtain the fused information, and determine the environment recognition result according to the fused information.

In some embodiments, the sound sensor can be arranged at the first position and the vision sensor can be arranged at the second position. The distance between the first position and the second position can be greater than or equal to 0 and less than the distance threshold. In some embodiments, when the distance between the first position and the second position is equal to 0, the sound sensor and the vision sensor can be integrated.

The control device based on environment sensing consistent with the disclosure can be configured to implement the control method based on environment sensing consistent with the disclosure (e.g., the method in FIG. 6). The implementation principles and technical effects of the control device 800 based on environment sensing are similar to those of the environment sensing method described above, and detailed description thereof is omitted herein.

FIG. 9 is a schematic structural diagram of an example vehicle 900 consistent with the disclosure. As shown in FIG. 9, the vehicle 900 includes a control device 901 based on environment sensing, a sound sensor 902, and a vision sensor 903. The control device 901 based on environment sensing can have a similar structure of the control device 800 in FIG. 8, and can execute the technical solutions of the control method based on environment sensing consistent with the disclosure (e.g., the method in FIG. 6). The implementation principles and technical effects of the control device 901 are similar to those of the control method based on environment sensing, and detailed description thereof is omitted herein.

It can be appreciated by those skilled in the art that some or all of the processes in the method consistent with the disclosure, such as one of the above-described exemplary methods, can be implemented by a program instructing relevant hardware. The program can be stored in a computer readable storage medium. When the program is executed, some or all of the processes in the method consistent with the disclosure can be implemented. The storage medium can comprise a read only memory (ROM), a random access memory (RAM), a magnet disk, an optical disk, or other media capable of storing program codes.

It is intended that the disclosed embodiments be considered as exemplary only and not to limit the scope of the disclosure. Changes, modifications, alterations, and variations of the above-described embodiments may be made by those skilled in the art within the scope of the disclosure.

What is claimed is:

1. A method comprising:
obtaining sound data captured by a sound sensor and image data captured by a vision sensor; and
determining an environment recognition result according to the sound data and the image data.

2. The method of claim 1, wherein determining the environment recognition result includes:
obtaining information carried by the sound data and the image data;
fusing the information to obtain fused information; and
determining the environment recognition result according to the fused information.

3. The method of claim 2, wherein fusing the information to obtain the fused information includes:
inputting the sound data to a first neural network to obtain a first output result; and
inputting the first output result and the image data to a second neural network to obtain a second output result, the second output result including:
a recognition result of a first channel of the second neural network that is related to the sound data, and
a recognition result of a second channel of the second neural network that is related to the image data.

4. The method of claim 3, wherein determining the environment recognition result according to the fused information includes:
determining the environment recognition result according to the recognition result of the first channel, a confidence level of the first channel, the recognition result of the second channel, and a confidence level of the second channel.

5. The method of claim 3, wherein determining the environment recognition result according to the fused information includes:
determining the environment recognition result according to the recognition result of the first channel, a confidence level of the first channel, a weight of the first channel, the recognition result of the second channel, a confidence level of the second channel, and a weight of the second channel.

6. The method of claim 5, wherein the weight of the first channel includes a fixed weight.

7. The method of claim 5, wherein the weight of the second channel includes a fixed weight.

8. The method of claim 5, wherein the weight of the first channel is positively related to a degree of influence on the vision sensor by an environment.

9. The method of claim 5, wherein the weight of the second channel is negatively related to a degree of influence on the vision sensor by an environment.

10. The method of claim 5,
wherein the second output result further includes feature information determined from the image data and configured to characterize a current environment state;
the method further comprising:
determining at least one of the weight of the first channel or the weight of the second channel according to the feature information.

11. The method of claim 3, wherein the first neural network is obtained by training based on sample sound data and an identification mark, the identification marks including an output result of the second neural network after sample image data corresponding to the sample sound data is input to the second neural network.

12. The method of claim 1, further comprising:
obtaining radar data captured by a radar sensor;
wherein determining the environment recognition result includes determining the environment recognition result according to the radar data, the sound data, and the image data.

13. The method of claim 12, wherein determining the environment recognition result according to the radar data, the sound data, and the image data includes:
fusing the radar data and the image data to obtain fused data;
obtaining information carried by the sound data and the fused data;
fusing the information to obtain fused information; and
determining the environment recognition result according to the fused information.

14. The method of claim 1, wherein:
the sound sensor is arranged at a first position;
the vision sensor is arranged at a second position; and
a distance between the first position and the second position is greater than or equal to 0 and less than a distance threshold.

15. The method of claim 14, wherein the distance between the first position and the second position is equal to 0, and the sound sensor and the vision sensor are integrated together.

16. The method of claim 1, further comprising:
controlling a vehicle according to the environment recognition result.

17. A non-transitory computer-readable storage medium storing a computer program including one or more codes that, when executed by a computer, cause the computer to perform the method of claim 1.

18. A device comprising:
a memory storing program codes; and
a processor configured to execute the program codes to:
obtain sound data captured by a sound sensor and image data captured by a vision sensor; and
determine an environment recognition result according to the sound data and the image data.

19. The device of claim 18, wherein the processor is further configured to execute the program codes to:
control a vehicle according to the environment recognition result.

20. A vehicle comprising:
a sound sensor configured to capture sound data;
a visual sensor configured to capture image data; and
a control device including:
a memory storing program codes; and
a processor configured to execute the program codes to:
obtain the sound data and the image data;
determine an environment recognition result according to the sound data and the image data; and
control the vehicle according to the environment recognition result.
